(19) United States
(12) Patent Application Publication
(10) Pub. No.: US 2026/0141098 A1
(43) Pub. Date: May 21, 2026

(54) STORAGE DEDUPLICATION OF NON-DETERMINISTICALLY ENCRYPTED DATA

(71) Applicant: Hewlett Packard Enterprise Development LP, Spring, TX (US)

(72) Inventors: Aditya Dhakal, Santa Clarita, CA (US); Kaiwen Cao, Urbana, IL (US); Pavana Prakash, Folsom, CA (US); Sai Rahul Chalamalasetti, Pleasanton, CA (US); Alex Veprinsky, San Ramon, CA (US); Dejan S. Milojicic, Palo Alto, CA (US)

(21) Appl. No.: 18/951,113

(22) Filed: Nov. 18, 2024

(51) Int. Cl. G06F 21/62; G06F 21/32

(52) U.S. Cl. CPC G06F 21/6218; G06F 21/32

(57) ABSTRACT

In example implementations, a computer system includes first memory for file storage and second memory storing a first mapping table and a second mapping table. The first mapping table associates user addresses with fingerprints and the second mapping table associates the fingerprints with storage locations of the first memory. Instructions cause one or more processors to receive an encrypted data file associated with a received user address and a fingerprint associated with the received encrypted data file. Based on the received fingerprint, it is determined whether the received encrypted data file is a duplicate of a previously stored data file. If the received encrypted data file is not a duplicate, the received encrypted data file is stored in the first memory and the first and second mapping tables are updated. If the received file is a duplicate, the first mapping table is updated.

### BACKGROUND

In modern computing environments, data generation and storage occur at an unprecedented scale. A typical enterprise system might encompass numerous workstations, servers, and applications, all continuously producing and manipulating data. This data ranges from user-created documents and spreadsheets to system logs, database records, and application outputs. Each day, users generate new files, modify existing ones, and collaborate on shared projects. Simultaneously, automated processes create backups, transaction logs, and analytical reports. All of this information needs to be stored, often in multiple locations for redundancy and accessibility. As the volume of data grows, so does the challenge of managing it efficiently.

Data deduplication is a specialized data compression technique used to eliminate duplicate copies of repeating data in storage systems. This process identifies and removes redundant data segments, replacing them with references to a single copy, thereby significantly reducing storage requirements. By storing only unique instances of data, deduplication can dramatically improve storage utilization, reduce backup times, and lower bandwidth needs for data transmission.

### BRIEF DESCRIPTION OF THE DRAWINGS

For a more complete understanding of this disclosure, and advantages thereof, reference is now made to the following descriptions taken in conjunction with the accompanying drawings, in which:

FIG. 1 depicts a system for managing storage of data files, according to example implementations.

FIGS. 2 and 3 depict computer devices that can be used in a computer system, according to example implementations.

FIG. 4 depicts a flowchart of a computer-implemented method for processing and transmitting non-deterministically encrypted data, according to example implementations.

FIG. 5 depicts a flowchart of a computer-implemented method for processing and storing non-deterministically encrypted data at a storage node, according to example implementations.

FIGS. 6A, 6B, and 6C, collectively FIG. 6, depict a non-deterministic encryption and deduplication system, according to example implementations.

FIG. 7 depicts a flowchart of a computer-implemented method for implementing a write operation, according to example implementations.

FIG. 8 depicts a flowchart of a computer-implemented method for implementing a read operation, according to example implementations.

FIG. 9 depicts a flowchart of a computer-implemented method for implementing an erase operation, according to example implementations.

FIGS. 10, 11, and 12A-12B depict systems for managing and processing non-deterministically encrypted data, according to example implementations.

### DESCRIPTION

The following disclosure provides many different examples for implementing different features. Specific examples of components and arrangements are described below to simplify the present disclosure. These are merely examples and are not intended to be limiting.

In recent years, the need for secure data storage and processing has become increasingly critical, particularly in sectors such as banking, government, and healthcare. These industries often deal with sensitive information that must be protected while still allowing for data analysis and machine learning applications. Homomorphic encryption has emerged as a promising solution, enabling computations on encrypted data without decryption. However, this approach significantly increases data size, leading to challenges in storage efficiency and scalability.

To address these challenges, example implementations propose a system for deduplicating homomorphically and other non-deterministically encrypted data. The system operates by generating fingerprints (e.g., hashes) of raw data on the client side before encryption. These fingerprints, along with the encrypted data, are then transmitted to a storage node. The storage node maintains two mapping tables: one associating user addresses with fingerprints and another linking fingerprints to specific storage locations. When new data arrives, the system uses these fingerprints to determine if identical encrypted data already exists in storage. If a match is found, the system merely updates the user address mapping, avoiding duplicate storage of encrypted data. For data retrieval, the system uses these mappings to locate and return the requested encrypted data.

Example implementations can substantially reduce storage requirements for non-deterministically encrypted data, addressing a major scalability concern in various applications, e.g., federated learning as but one example. Secondly, data privacy and security are maintained throughout the process, as all operations on the storage side are performed on encrypted data and fingerprints. Thirdly, the system can improve overall performance by reducing data transmission costs and enabling more efficient data management. Various implementations, which incorporate both client side processing and centralized storage, are well-suited for distributed systems and large-scale machine learning applications.

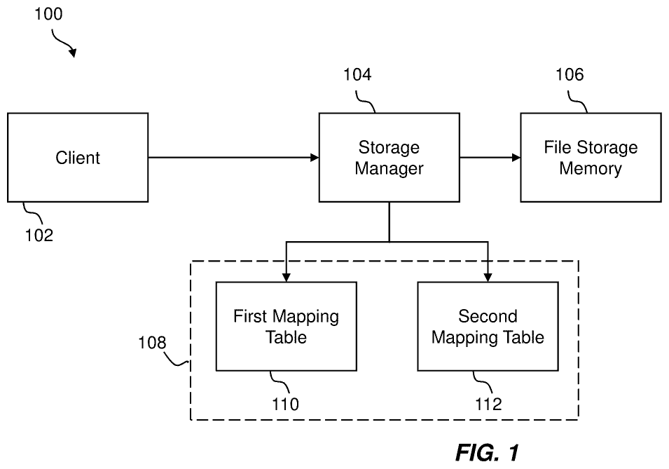

FIG. 1 illustrates a system 100 for managing storage of encrypted data files. The system includes a client 102, a storage manager 104, memory 106 that serves for file storage (referred to as “file storage memory” or simply “file storage”), and memory 108 that stores a first mapping table 110 and a second mapping table 112. The client 102 is connected to the storage manager 104, which in turn interacts with the file storage memory 106 and the two mapping tables 110 and 112. The client 102 can be referred to as a client node while the remaining elements are referred to as a storage node. The storage node can be implemented, e.g., with solid state drives (SSD) with FPGA(s) (field programmable gate array(s)) in the front end.

The system 100 is designed to efficiently store and manage encrypted data files, particularly but not necessarily homomorphically or other non-deterministically encrypted data, while implementing deduplication to optimize storage usage. The client 102 represents the source of encrypted data files and associated metadata. The storage manager 104 serves as the component that coordinates the storage operations and interactions with other system elements. When implementing the deduplication processes, the storage manager may be referred to as a deduplication engine.

A single file may be encrypted in blocks where each block is associated with a logical block address. In other words, multiple logical block addresses can be used to identify blocks that make up an entire file. The block size can be fixed by the user or operator. It is understood that the term file as used herein includes an entire file or a block of a file.

The client 102 represents an endpoint device or system that interacts with the storage management system. In an example implementation, the client 102 is responsible for generating and transmitting encrypted data files to the storage manager 104. The client 102 may include hardware and software components for performing encryption operations, e.g., homomorphic encryption, on raw data. Additionally, the client 102 may generate fingerprints or hash values associated with the raw data before encryption. These fingerprints serve as unique identifiers for the data, facilitating deduplication processes in the storage system. The client 102 may also include functionality for compressing the encrypted data and for secure communication with the storage manager 104 to ensure the confidentiality and integrity of transmitted data.

The client 102 may be implemented using various hardware configurations suitable for performing encryption and data processing tasks. In an example implementation, the client 102 includes one or more processors, such as central processing units (CPUs) or graphics processing units (GPUs), coupled with memory modules like RAM (random access memory) and storage devices. The client 102 may also incorporate specialized hardware accelerators designed to efficiently perform non-deterministic encryption operations. These accelerators can be implemented as field-programmable gate arrays (FPGAs) or application-specific integrated circuits (ASICs) to optimize the performance of complex cryptographic computations. Network interface components, e.g., SmartNICs, are included to facilitate communication with the storage manager 104, enabling secure data transmission over various protocols.

The file storage memory 106 represents the physical or virtual storage infrastructure where encrypted data files are stored within the system 100. In an example implementation, the file storage memory 106 comprises one or more storage devices, such as solid-state drives (SSDs), hard disk drives (HDDs), or a combination of both. Tape drives can be used for long-term storage applications. These storage devices may be organized into arrays or clusters to provide scalability and redundancy. The file storage memory 106 is designed to efficiently store and retrieve data files, which in implementations are non-deterministically encrypted and therefore typically have larger sizes compared to unencrypted data. The storage system may implement various data management techniques, such as data striping or distributed storage across multiple devices, to optimize performance and reliability. The file storage memory 106 interacts directly with the storage manager 104, which coordinates read and write operations based on the information maintained in the mapping tables 110 and 112.

The storage manager 104 orchestrates the storage and retrieval of encrypted data files. It acts as an intermediary between the client 102 and the file storage memory 106, implementing deduplication strategies to optimize storage utilization. In an example implementation, the storage manager 104 is a software module running on a dedicated server or distributed across multiple nodes in a cluster.

The storage manager 104 works in conjunction with two data structures, shown as the first mapping table 110 and the second mapping table 112. In the example of FIG. 1, the mapping tables are stored in a memory 108. This memory 108 can be a memory local to storage manager 108 or remote within the network. The memory 108 can be a single memory device or distributed amongst memory devices. Examples of memory 108 can include SSD, HDD, or non-volatile memory such as flash. During operation, the mapping tables can be kept in RAM.

The first and second mapping tables 110 and 112 enable efficient deduplication and management of stored encrypted data files. The first mapping table 110 associates user addresses, e.g., logical block addresses, with fingerprints. Each user address corresponds to an encrypted data file, and the fingerprint serves as a unique identifier generated from the original unencrypted data. This table allows the storage manager 104 to determine if a newly received encrypted file is a duplicate of an existing file, based on its fingerprint. In certain implementations, the fingerprint is related to a block of data from an encrypted file.

The second mapping table 112 associates the fingerprints with actual (physical or virtual) storage locations in the file storage memory 106. This two-level mapping approach enables the storage manager 104 to implement efficient deduplication. When a new encrypted file is received, the storage manager 104 checks the first mapping table 110 to see if a matching fingerprint exists. If a match is found, it indicates a potential duplicate. The storage manager 104 then uses the second mapping table 112 to locate the existing file in the file storage memory 106, avoiding the need to store duplicate data.

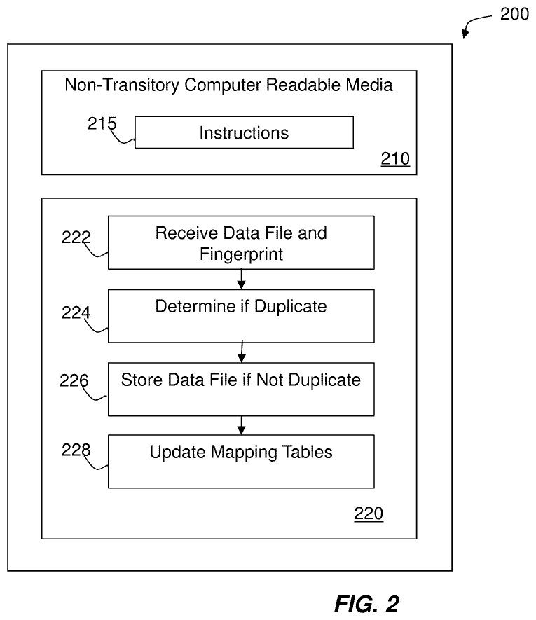

FIG. 2 provides an example implementation of a computer device 200 that can implement the functionality of storage manager 104. The computer device 200 includes a non-transitory computer-readable medium, i.e., memory, 210 and one or more processors 220. The memory 210 stores instructions 215 that can be executed by the processor(s) 220. In this example, the processor(s) 220 are programmed to receive an encrypted data file that is associated with a received user address and a received fingerprint associated with the received encrypted data file (222). Based on the received fingerprint, it is determined whether or not the received encrypted data file is a duplicate of a previously stored encrypted data file (224). The received encrypted data file is stored in the file storage and the first and second mapping tables are updated when the received encrypted data file is not a duplicate of any previously stored encrypted data file (226). When the received encrypted data file is a duplicate of a previously stored encrypted data file, the first mapping table is updated to associate the received user address with an existing fingerprint and the file will not be stored (228).

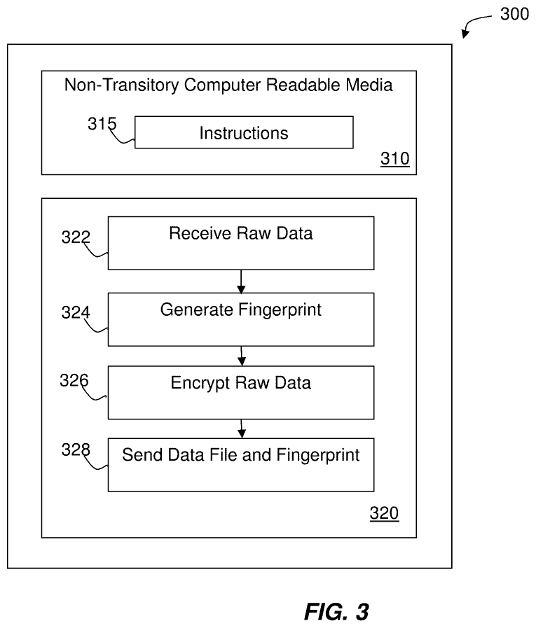

FIG. 3 provides an example implementation of a computer device 300 that can implement the functionality of the client side component. Similar to computer device 200, the computer device 300 includes memory 310 and one or more processors 320. The memory 310 stores instructions 315 that can be executed by the processor(s) 320. In this example, the processor(s) 320 are programmed to receive raw data (322) and generate the fingerprint from the raw data (324). After generating the fingerprint, the raw data can be encrypted using non-deterministic encryption to produce the encrypted data file that is being sent to the storage node. While shown separately, functions of the computer devices 200 and 300 can be implemented on the same set of processors in various implementations.

Further details and specific examples are discussed below.

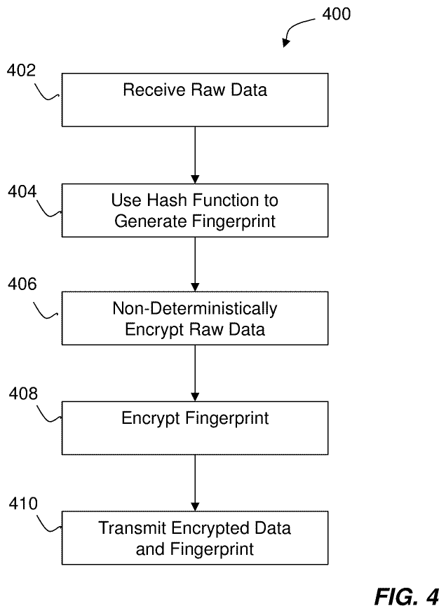

FIG. 4 illustrates a flowchart 400 of a computer-implemented method for processing and transmitting non-deterministically encrypted data. The method begins with receiving raw data at step 402. This raw data may be any type of data that requires secure storage and processing while maintaining its confidentiality.

In step 404, a hashing function is applied to the raw data to generate a fingerprint. The fingerprint serves as a unique identifier for the raw data, allowing for efficient comparison and deduplication processes without revealing the actual content of the data. Various cryptographic hash functions or algorithms may be used for this purpose.

In an example implementation, the hashing process utilizes a cryptographic hash function such as SHA-256 (Secure Hash Algorithm 256-bit). The raw data is input into the hash function, which then produces a fixed-size output, typically 256 bits for SHA-256. Other options for creating the fingerprint include SHA-1, which is faster but also less secure. SHA-512 is another part of the SHA-2 family and offers higher security with a larger hash size but is slower than SHA-256. Blake2 is an option that might be faster than SHA-2 and still provides strong security. Another alternative that provides a 160-bit hash value is RIPEMD-160, which offers a balance between speed and security.

This output of the hashing process serves as the fingerprint for the raw data. The hashing process is typically designed to be non-deterministic, i.e., the same input can lead to different outputs. In other implementations, the hashing process is deterministic, i.e., identical input data will always produce the same fingerprint. However, even a small change in the input data results in a different fingerprint. Moreover, the hash function is designed to be one-way, making it computationally infeasible to reconstruct the original raw data from the fingerprint. This characteristic enhances the security of the overall system by ensuring that the fingerprint does not reveal information about the raw data it represents.

In step 406, the raw data undergoes non-deterministic encryption to generate a non-deterministically encrypted data file. In an example implementation, hardware accelerators may be employed to perform the non-deterministic encryption process more efficiently. These accelerators can be specialized hardware components designed to speed up complex cryptographic operations.

In example implementations, homomorphic encryption is implemented. The process of homomorphic encryption enables computations on encrypted data without decrypting it. The raw data is first converted into a suitable format for encryption, typically represented as integers or polynomials. The encryption process then applies mathematical transformations to this data using a public key, resulting in the homomorphically encrypted data file. This encrypted file contains the original information in a form that allows for specific mathematical operations to be performed directly on the ciphertext. In other words, the homomorphic encryption process ensures that the encrypted data remains secure while still allowing for meaningful computations to be performed on it. This capability is particularly useful in scenarios where sensitive data needs to be processed or analyzed without exposing the underlying information, such as in cloud computing environments or collaborative data analysis projects.

The encryption process can involve complex mathematical operations, including modular arithmetic and lattice-based cryptography. In an example implementation, the homomorphic encryption process uses an encryption scheme, such as the Brakerski/Fan-Vercauteren (BFV) scheme or the Cheon-Kim-Kim-Song (CKKS) scheme, which allows for both addition and multiplication operations on encrypted data. To optimize performance, hardware accelerators such as GPUs (graphics processing units) or FPGAs (field programmable gate arrays) may be utilized. These accelerators can significantly speed up the encryption process by parallelizing the computations involved.

In other implementations, other non-deterministic encryption techniques can be used. Each of these encryption techniques can produce different ciphertext outputs for identical input files. These techniques include probabilistic encryption or randomized encryption. Deterministic encryption techniques can also benefit from concepts discussed herein, e.g., when the encrypted files are large so that comparing fingerprints saves time or computing resources. In fact, the concepts discussed here can be used with non-encrypted files as well.

Examples of non-deterministic encryption techniques include Advanced Encryption Standard (AES) in Cipher Block Chaining (CBC) mode, which employs a random initialization vector to ensure different ciphertexts for identical plaintexts. RSA with Optimal Asymmetric Encryption Padding (OAEP) incorporates randomness into the padding process, enhancing security and achieving semantic security. ElGamal encryption, a public-key cryptosystem, uses random values in its encryption operation, producing varying ciphertexts for the same message and key. The Paillier cryptosystem, notable for its homomorphic properties, also employs randomness to achieve semantic security. AES in Galois/Counter Mode (GCM) utilizes a nonce, typically randomly generated, to provide both confidentiality and authenticity while ensuring different outputs for identical inputs. ChaCha20-Poly1305, a more recent authenticated encryption algorithm, similarly uses a nonce to achieve non-deterministic encryption.

After encryption, the resulting encrypted data file is typically larger than the original raw data. To address this, a lossless compression step may be applied to reduce the size of the encrypted data without compromising its homomorphic properties. This compression can be performed in a bump-in-the-wire fashion, integrated seamlessly into the data processing pipeline to minimize additional latency.

In step 408, the fingerprint generated in step 404 can optionally be encrypted. This encryption of the fingerprint provides an additional layer of security, protecting the identifier of the raw data from unauthorized access or tampering. In an example implementation, the fingerprint encryption utilizes a symmetric encryption algorithm such as Advanced Encryption Standard (AES). The fingerprint, typically a fixed-length output from the hashing function, serves as the input to the encryption algorithm. A secret key, known only to authorized parties, is used to encrypt the fingerprint. The encryption process transforms the fingerprint into a ciphertext that cannot be easily reversed without knowledge of the secret key.

This encrypted fingerprint can be transmitted and stored alongside the encrypted data file without revealing information about the original data. The choice of a symmetric encryption algorithm for this step allows for fast and efficient encryption and decryption operations, which can be helpful given the frequency of fingerprint comparisons in the deduplication process. In example implementations, the encrypted fingerprint will result in a different cipher text even if the raw fingerprint is the same and the cipher text is relatively small, enabling less overhead for security protection while maintaining its confidentiality. In other implementations, the encrypted fingerprint retains the same property as the original fingerprint-identical raw data inputs will result in identical encrypted fingerprints, enabling efficient deduplication at the storage node while maintaining data confidentiality.

Finally, in step 410, the encrypted data file along with the encrypted fingerprint is transmitted to the storage node. In an example implementation, this transmission may also include sending a user address associated with the encrypted data file and the encrypted fingerprint. The user address can be used for efficient retrieval and management of the stored data.

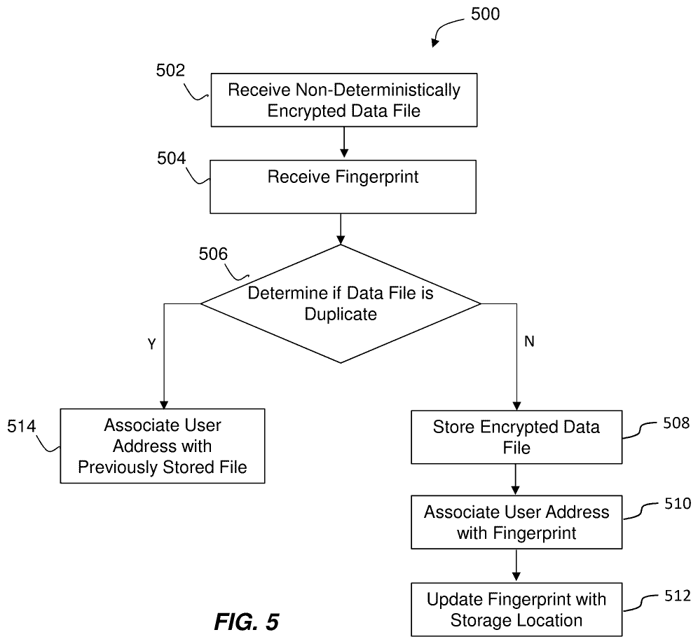

FIG. 5 illustrates a flowchart 500 of a computer-implemented method for processing and storing non-deterministically encrypted data at the storage node. The method begins at step 502 with the storage node receiving an encrypted data file, e.g., the data file transmitted in step 410 of FIG. 4.

In step 504, the storage node receives a fingerprint associated with the non-deterministically encrypted data file. This fingerprint, generated and possibly encrypted at the client side as described in relation to FIG. 4, serves as a unique identifier for the underlying raw data. Upon receipt, the storage node decrypts the fingerprint using the appropriate decryption key.

The method proceeds to step 506, where the storage node determines whether the received encrypted data file is a duplicate of a previously stored file. This determination is based on the received fingerprint. In an example implementation, the storage node accesses a mapping table that associates fingerprints with storage locations of previously stored encrypted data files. By comparing the received fingerprint against entries in this mapping table, the storage node can identify potential duplicates without decrypting the actual data files.

If the determination in step 506 indicates that the received file is not a duplicate, the process moves to step 508. Here, the storage node stores the encrypted data file in its storage system. The storage location of this newly stored file is then recorded. In step 510, the user address sent along with the data file is associated with the received fingerprint. In step 512, this fingerprint is mapped to an actual storage location. In this manner, the user address can be correlated with the storage address for future access.

If the determination in step 506 indicates that the received file is a duplicate of a previously stored file, the process skips the storage step and moves directly to step 514. In this step, the storage node associates the user address of the received file with the previously stored encrypted data file. This association may be accomplished by updating a mapping table that links user addresses with fingerprints as in step 510. In other words, the received user address is associated with the fingerprint of the previously stored data file, which is a duplicate of the received file.

The process outlined in FIGS. 4 and 5 enables efficient deduplication of non-deterministically encrypted data at the storage node level. This approach can conserve storage space and reduce data redundancy while maintaining the security and privacy benefits of encryption. The usage of fingerprints allows for duplicate detection without compromising the confidentiality of the encrypted data, as the actual content remains inaccessible throughout the process.

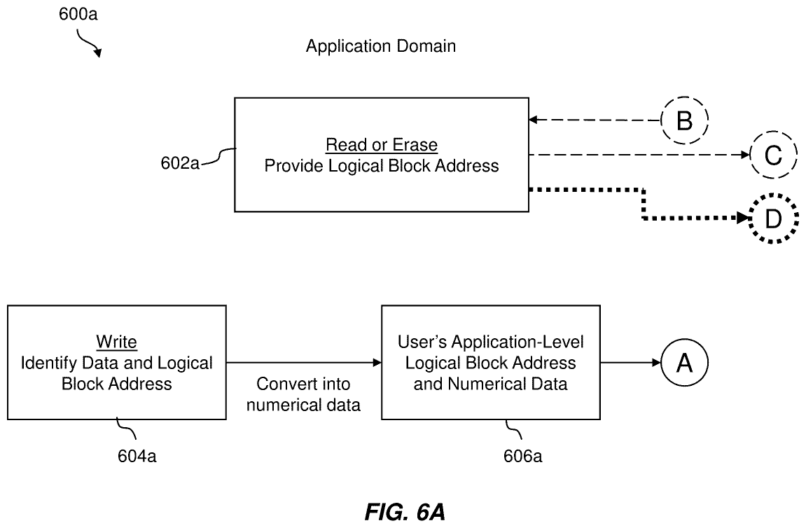

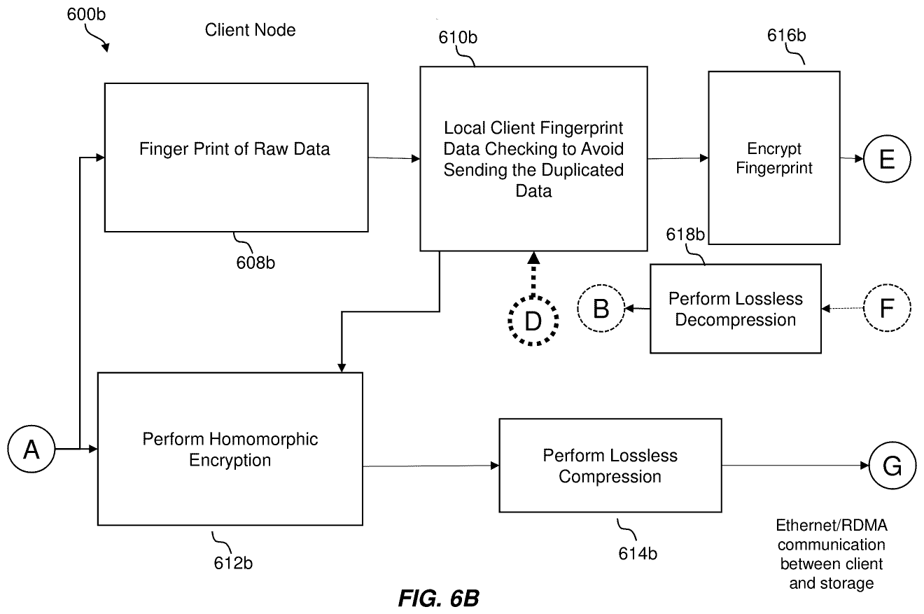

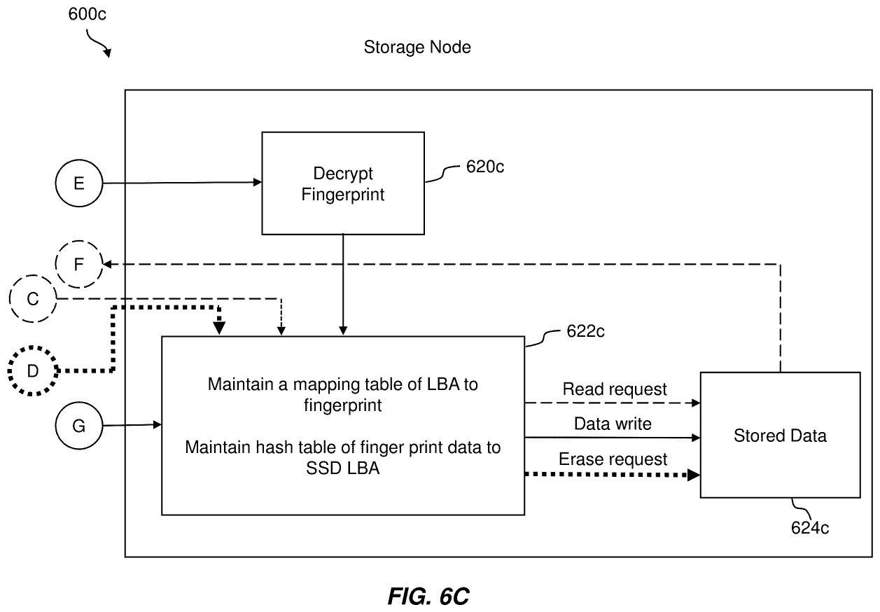

FIGS. 6A, 6B, and 6C, collectively FIG. 6, illustrate a comprehensive implementation of a homomorphic encryption and deduplication system according to an example implementation. Similar systems can be implemented for other types of encryption. FIG. 6 depicts the flow of data from the application domain (FIG. 6A) through the client node (FIG. 6B) to the storage node (FIG. 6C). These blocks can be used to illustrate a potential flow for write, read, and erase functions. Each of the reference numbers has an “a,” “b,” or “c” to help locate where in FIG. 6 the block is located.

The write operation will first be described with FIG. 6, where this operation is shown with solid lines. Beginning at block 604a in the application domain 600a, the user identifies data to be homomorphically encrypted for storage. The data can be, for example, numerical data, binary data, text data, or image data. The user will also associate the data with a user address or logical block address.

If the data is not numerical, the data is processed to enable homomorphic encryption, e.g., converted into numerical data. Non-numeric data can be converted to numeric data through various encoding techniques. For text data, each character can be assigned a numeric value based on its ASCII or Unicode representation. Binary data can be interpreted as a series of bits and converted to decimal or hexadecimal numbers. For more complex data types like images, techniques such as pixel value representation or feature extraction can be used to generate numeric representations. The result, i.e., the user address and numerical data, is shown in block 606a.

This data can then be provided to the client node 600b. In block 608b, the raw data is passed to a hashing engine (e.g., SHA-256) to obtain the fingerprint of the raw data. In an example implementation, an encoding is performed on the numerical data using an FPGA or GPU.

In block 610b, the fingerprint data will be checked through a data structure to ensure that duplicate data within a user is not sent. This check is done at the local node to assist in network bandwidth optimization. This operation can be performed on an FPGA or directly on the GPU/CPU where the data originated, as two examples.

In an example implementation, the duplicate checking is performed using a Bloom filter, which is a space-efficient probabilistic data structure used to test whether an element is a member of a set. This filter uses multiple hash functions to map each element to a bit array (e.g., the contents of the fingerprint), setting the corresponding bits to 1. To check if an element is in the set, the filter hashes the element and checks if all corresponding bits are 1; if any bit is 0, the element is definitely not in the set, while if all bits are 1, the element is likely in the set with a small probability of false positives.

Several alternative structures can be used to check if a fingerprint is a duplicate. Hash tables provide fast lookups and can store the actual fingerprints, allowing for exact matching but potentially requiring more memory. These structures can efficiently store and search for fingerprints, especially if they share common prefixes. Cuckoo filters offer similar functionality to Bloom filters but support deletion and have lower false positive rates. Binary search trees or self-balancing trees like Red-Black trees can be used for ordered storage and efficient searching of fingerprints. Each structure offers different trade-offs between memory usage, lookup speed, and false positive rates, allowing for optimization based on specific system requirements.

If the local client is trying to send the same data again, there is no need to encrypt or send the data. Instead, the metadata in the storage node will be updated by associating the logical block address from block 606a with a fingerprint that is already recognized by the storage node. In other words, the process may skip to step 622c (although no arrow is shown in the figure). Omitting the unnecessary steps can help in storage performance by not sacrificing bandwidth by retransmitting duplicate data.

If local client is not trying to send the same data again, a non-deterministic encryption scheme such as the homomorphic encryption (HE) engine starts to encrypt the raw data as shown in block 612b. As discussed above, an encoding can be performed on the numerical data along with an actual encryption of the encoded data. The encryption can be performed by an FPGA or GPU in various implementations.

The encrypted data can then be compressed, e.g., in a lossless compression step as shown in block 614b. In example implementations, the compression can be performed on an FPGA. The lossless compression step reduces the overall size of the encrypted data without compromising its integrity or the ability to perform homomorphic operations. This optimization helps in reducing storage requirements and improving data transfer efficiency between the client node and the storage node.

Lossless compression in the homomorphic encryption and deduplication system can be implemented using various algorithms optimized for FPGA execution. In an example implementation, the system utilizes the Vitis library's compression modules, which offer efficient FPGA-accelerated versions of popular lossless compression algorithms. The compression process begins by dividing the homomorphically encrypted data into blocks of appropriate size for the chosen algorithm.

In other implementations, the lossless compression can be implemented in a programmable accelerator such as a SmartNIC (smart network interface card). For example, a BlueField SmartNIC can be used. Other hardware, such as WAN optimization appliances, routers, storage area network switches, and load balancers, can assist with the lossless compression.

Common lossless compression techniques that can be employed include run-length encoding (RLE), which replaces sequences of identical data elements with a single data value and count. Huffman coding uses an algorithm that assigns variable-length codes to input characters, with shorter codes for more frequent characters. Lempel-Ziv-Welch (LZW) uses a dictionary-based algorithm to build a dictionary of data sequences encountered in the input data. Arithmetic coding provides a technique that represents frequently used characters using fewer bits and rarely used characters using more bits.

The FPGA implementation can allow for parallel processing of multiple data blocks, speeding up the compression process. The compressed data is then packaged with necessary metadata, such as the compression algorithm used and any required dictionary or coding tables. To ensure that the compression remains lossless, the system can implement integrity checks, verifying that the decompressed data exactly matches the original input. This may involve calculating and storing checksums or hash values of the original data for later verification.

If the encryption was performed on a GPU and the compression on an FPGA or SmartNIC, an efficient peer-to-peer data transfer can be performed, for example, using direct memory access (DMA) techniques. In an example implementation, both the GPU and FPGA or SmartNIC are connected to the same PCIe bus, allowing for direct data exchange without involving the host CPU or system memory. The process typically involves setting up shared memory regions that both devices can access and using specialized hardware features for GPUs and DMA engines on FPGAs or SmartNICs. The data transfer can be further optimized by aligning data structures, using pinned memory, and implementing efficient synchronization mechanisms between the GPU and FPGA or SmartNIC.

When the fingerprint is determined not to be a duplicate, an encryption step can be performed as shown by block 616b. In an example implementation, traditional AES encryption is performed on the fingerprint data to obtain AES-encrypted fingerprint data. Other encryption techniques can alternatively be used. The encryption can be performed to avoid a potential brute-force attack on the fingerprint/hash data. This encryption can be performed on a GPU or FPGA, as examples.

The actual HE data and encrypted fingerprint are sent from the client node 600b to the remote storage node 600c. In example implementations, Ethernet or remote direct memory access (RDMA) can be used for communication between client and storage.

As shown by block 620c, the fingerprint is decrypted at the storage node, e.g., with AES decryption. AES is symmetric encryption so that the client and storage share the same key. The decryption can be performed on an FPGA.

The mapping tables are updated as shown by block 622c. This function can be performed by the storage manager or deduplication engine discussed with respect to FIG. 1. As discussed above, a first mapping table maps the user's application-level logical block address (LBA) to its associated the fingerprint mapping. A second mapping table can maintain the hash table of fingerprint data to deduplicated storage address, e.g., an SSD LBA. Both mapping tables can be implemented with an FPGA.

Block 624c represents the stored data. As noted above, the data storage can be implemented with SSD or HDD, as examples. For long-term storage, other storage technologies such as tape drives can be used. The deduplicated LBA specifies the address and the data is stored as compressed HE data.

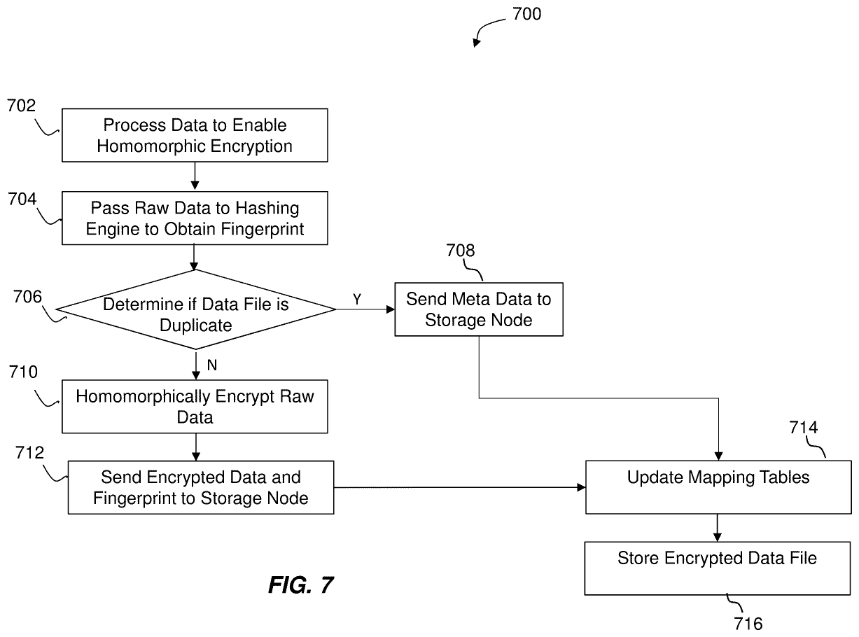

The steps of the write operation are summarized in the flowchart 700 shown in FIG. 7. Briefly, the data is processed in step 702 to enable homomorphic encryption. In step 704, the raw data is passed to the hashing engine to obtain the fingerprint. Step 706 determines if the data is a duplicate. If so, metadata is sent to the storage node (step 708). If not, the raw data is homomorphically encrypted in step 710. The encrypted data and fingerprint can then be sent to the storage node (step 712). At the storage node, the mapping tables are updated (step 714) and the encrypted data file is stored (step 716).

Returning to FIG. 6, the read operation with be discussed with respect to the dash-lined arrows. The read operation starts in block 602a of the application domain 600a. Here the user provides the logical block address to be read from. The request is sent to the storage node 600c where it is received at block 622c.

The storage node 600c uses the mapping tables to translate the user-level logical block address to the actual storage address by using the fingerprint data (block 622c). As before, the client address is associated with a fingerprint, which is associated with the physical or virtual address of the encrypted file to be retrieved. During the process, the file to be retrieved remains encrypted.

In response to the read request, the stored data from block 624c is returned to the client node 618b. Here the compressed file can be decompressed. For example, a method complementary to the lossless compression in block 614b can be performed. For example, the decompression can be performed on an FPGA using the Vitis library's or SmartNIC's decompression modules.

The homomorphically encrypted file is then returned to the application domain 600a as represented by block 602a. The application can then decrypt the file for whatever use is intended.

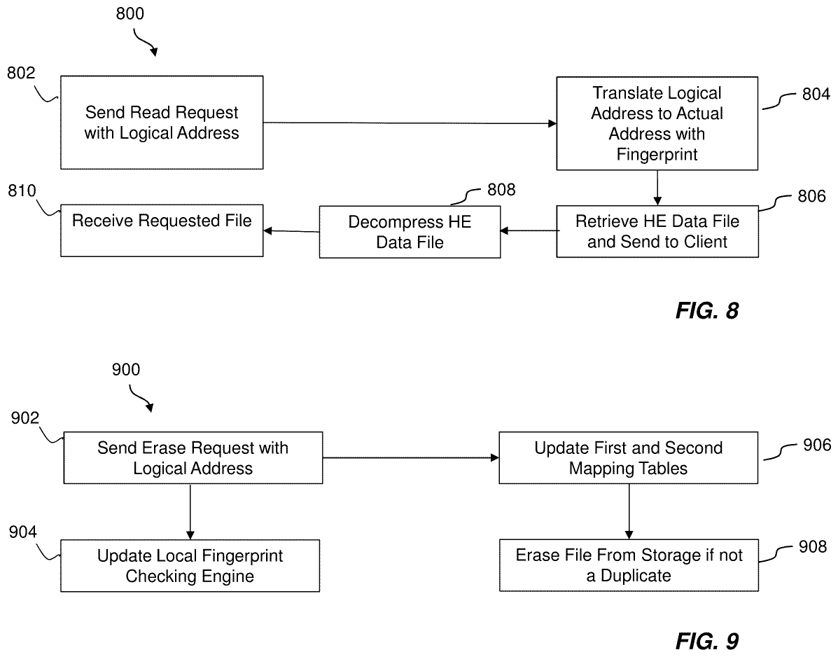

The steps of the read operation are summarized in the flowchart 800 shown in FIG. 8. Briefly, the read request and user logical block address are sent in step 802. The user logical block address is translated to an actual address with the fingerprint in step 804. The actual address is used to retrieve the encrypted file, which is sent to the client node if decompression is needed (step 806). The decompression can be performed in step 808 and the requested file provided to the user in step 810. If the file was not compressed, it can (but not need to) be transmitted directly from the storage node to the application domain.

The erase operation will now be discussed with reference to the bolded dotted lines in FIG. 6. In block 602a, the application provides a logical block address to the local client fingerprint engine 610b and the storage node mapping table tables 622c. The tables in each are updated to indicate that the file is being erased. For example, the storage node can update the user logical block address-to-fingerprint mapping table and the fingerprint-to-actual address mapping table in block 622c. A similar update is performed by the client in block 610b.

Alternatively, some implementations might predict that the same file will again be stored in which case the file is not erased. A fingerprint to this file is saved even though no user address is associated with the fingerprint. This approach could be helpful in saving network bandwidth in cases where the same file might be stored at a later date.

The steps of the erase operation are summarized in the flowchart 900 shown in FIG. 9. Briefly, the erase request and user logical block address are sent in step 902. In step 904, the local fingerprint-checking engine is updated so that the fingerprint is no longer associated with the logical block address corresponding to the file to be erased. In step 906, the first and second mapping table are updated. If the mapping tables indicate that no other fingerprint is associated with the file in question, this file can be erased from storage (step 908).

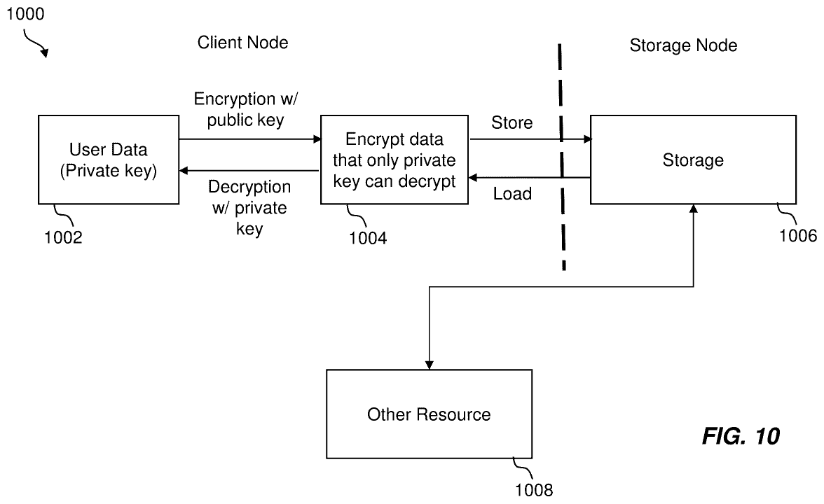

FIGS. 10, 11, and 12 provide three examples of where the encryption and deduplication system can be implemented. The simplified representations provided in these figures can be implemented with any combination of the examples discussed above.

FIG. 10 illustrates a system 1000 for managing and processing homomorphically encrypted data. This implementation can be useful for a single user that will homomorphically encrypt its data to store it with better privacy. The system 1000 includes block 1002 representing the user data and block 1004 representing the encryption in the client node. The storage node includes block 1006, which represents the storage.

In an example implementation, the client node block 1002 represents the user data, which is associated with a private key. This data can be encrypted using a public key. The result is encrypted data that only the private key can decrypt as noted by block 1004. The encrypted data can be stored at the remote storage node 1006. Whenever the data is needed, it can be loaded to the client or another resource 1008 for potential operation, e.g., addition or multiplication. If the data has been homomorphically encrypted, these operations can be performed without decryption. The data can be decrypted with the private key to view the raw data.

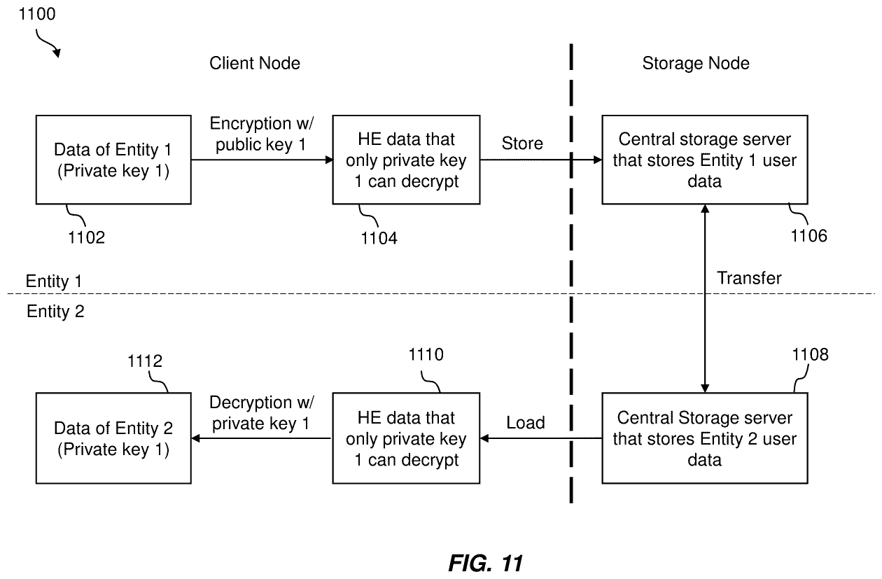

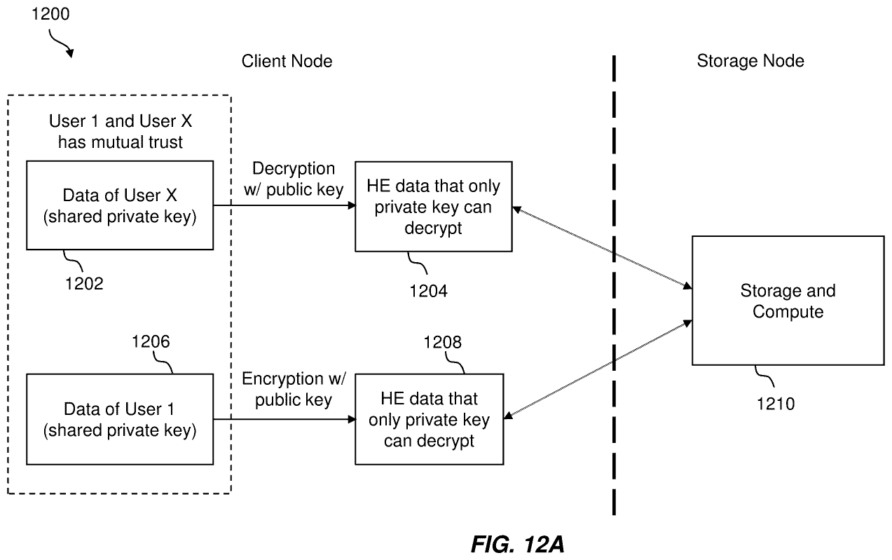

FIG. 11 depicts a system 1100 as another example implementation. This system can be used for secure data management and transfer between multiple entities using homomorphic encryption. The system is represented at the client node by data block 1102 and encrypted data block 1104 of a first entity and data block 1112 and encrypted data block 1110 of a second entity. The storage node includes central storage server 1106 of the first entity and central storage server 1108 of the second entity.

This example will be described in the context of banking. Explanation of the implementation is simplified by referring to an example context, but it is understood that the implementation is not limited to banking.

In banks, there are multiple clients who store data in the bank's storage. The data stored are sensitive data, e.g., account balance numbers or transactions. The homomorphic encryption can be a solution to provide a better privacy when performing addition and multiplication for clients'data. For example, when there is an incoming or outgoing transfer initiated by the user from the two banks, the accounts'balance in both banks need to reflect these changes.

In illustrated example, the client node represents a user with accounts in both Entity 1 (Bank A in this example) and Entity 2 (Bank B in this example). The user's data, such as account balances or transaction histories, is encrypted using homomorphic encryption with a public key specific to the user. This encryption process occurs in the encryption module 1104, which may be part of the client node or a separate secure component.

The encrypted data from block 1104 is transmitted to and stored in the central storage server 1106 of Bank A. Similarly, encrypted data from block 1110 of Bank B is stored in the central storage server 1108 of Bank B. These servers securely store the homomorphically encrypted data, maintaining user privacy while allowing for necessary computations on the encrypted data.

When a transfer between accounts in Bank A and Bank B is initiated, the system utilizes the homomorphic properties of the encrypted data. The transfer mechanism facilitates the secure movement of encrypted funds between the two banks. This process involves performing operations directly on the encrypted data, such as addition or subtraction, without decrypting the information. For example, the balance information stored storage 1106 of Bank A can be increased by the transfer amount while the balance information stored storage 1108 of Bank B is decreased by the same amount. Because of the homomorphic encryption, the actual account information is inaccessible at the storage node.

Upon retrieval of data by the user, the decryption module 1110 uses the user's private key to decrypt the homomorphically encrypted information, providing access to the original data. This decryption occurs only at the client node, ensuring that the banks never have access to the unencrypted or raw user data. The storage and deduplication techniques disclosed herein can be utilized for this transaction.

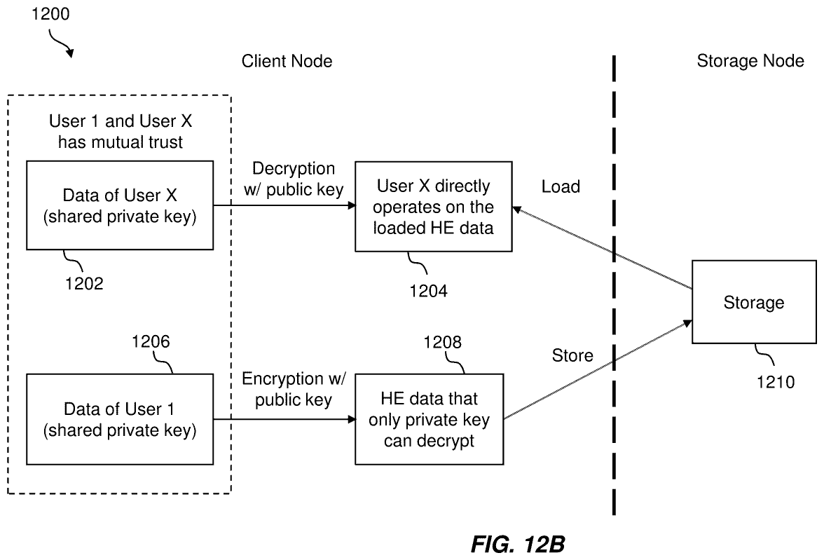

FIG. 12A illustrates a system 1200 for implementing secure federated learning using homomorphic encryption. Again, this is but one example. In this case, each user has their own private data and they collaboratively train a machine learning model for a task. Due to privacy concerns, it is not desirable to share the private data directly. So, to get a high-quality model, each user's model weights can be aggregated together to form a global weight and broadcast back to each user. To protect the privacy, the model weights are not directly uploaded to a remote storage server. In this case, the homomorphic encryption is able to protect the data, while enabling the weight aggregation (addition/multiplication operation). In another example, companies could collaboratively analyze market trends without sharing sensitive sales data.

The system 1200 comprises a client node where User 1 and User X have a mutual trust and share a private key. In the example shown, User 1 homomorphically encrypts the data from block 1206 with a public key and User X homomorphically encrypts the data from block 1202 with the same public key. The encrypted data from blocks 1204 and 1208 is stored on the remote storage/compute node 1210. The storage/compute node 1210 can perform arithmetic operations, e.g., weight aggregation (addition/multiplication operation). The encrypted data can be sent back to user 1 and user X where it can be decrypted with the common private key.

FIG. 12B depicts a similar system. In this case, the encrypted data from User 1 can be stored from block 1208 to the storage node 1210. This encrypted data can then be loaded to block 1204 where operations such as addition and multiplication can be performed. After the operations are complete, the encrypted data is stored in storage node 1210, where is can be accessed and decrypted by both the User 1 and User X.

While the banking and federated learning contexts provide examples, the architecture disclosed herein can be applied to various other fields where secure data sharing and processing are implemented.

For example, in healthcare, the system could be used for sharing patient data between different healthcare providers or research institutions. Patient records, test results, and treatment data could be encrypted and stored securely, allowing for collaborative research or treatment planning without compromising patient privacy. Analytics could be performed on aggregated data from multiple sources without exposing individual records. For example, pharmaceutical companies could pool research data for joint analysis without risking intellectual property exposure. This could also be useful in fields like epidemiology.

In government, different government departments could share sensitive information securely. For example, tax information, census data, or intelligence could be processed across agencies without exposing raw data. The architecture could be adapted for electronic voting systems, allowing for vote tallying and verification while maintaining ballot secrecy.

Another example is in supply chain management where companies within a supply chain could share inventory levels, production schedules, or shipping data without revealing proprietary information to competitors who may be part of the same chain.

In education, student records and performance data could be shared between schools, districts, or universities for research or transfer purposes while maintaining student privacy.

As another example, insurance companies could securely share and process claim data, risk assessments, or policyholder information across different branches or with partner companies. Other financial institutions could jointly develop risk assessment models or perform stress tests using combined data sets without exposing proprietary information.

In the context of secure auctions, the system could facilitate secure bidding processes where bid values remain encrypted until the auction concludes, preventing manipulation and maintaining fairness.

Privacy-preserving recommendation systems used by market research and analytics companies can implement systems as disclosed herein. For example, online platforms could generate personalized recommendations based on aggregated user behavior without accessing individual user data.

In each of these contexts, the system would operate with data encrypted using homomorphic encryption, stored securely, processed in its encrypted form, and only decrypted by authorized parties with the proper private key. This approach enables collaborative computation and analysis while maintaining data privacy and security.

Although this disclosure describes or illustrates particular operations as occurring in a particular order, this disclosure contemplates the operations occurring in any suitable order. Moreover, this disclosure contemplates any suitable operations being repeated one or more times in any suitable order or occurring at substantially the same time, where appropriate. Any suitable operation or sequence of operations described or illustrated herein may be interrupted, suspended, or otherwise controlled by another process, such as an operating system or kernel, where appropriate. The steps can operate in an operating system environment or as stand-alone routines occupying all or a substantial part of the system processing.

While this disclosure has been described with reference to illustrative implementations, this description is not intended to be construed in a limiting sense. Various modifications and combinations of the illustrative implementations, as well as other implementations of the disclosure, will be apparent to persons skilled in the art upon reference to the description. It is therefore intended that the appended claims encompass any such modifications or implementations.

What is claimed is:

1. A computer system comprising:
first memory for file storage;
second memory storing a first mapping table and a second mapping table, the first mapping table associating user addresses with fingerprints and the second mapping table associating the fingerprints with storage locations of the first memory, wherein each user address associated with an encrypted data file;
one or more processors; and
a non-transitory computer-readable medium storing instructions that, when executed by the one or more processors, cause the one or more processors to:
receive a received encrypted data file that is associated with a received user address;
receive a received fingerprint associated with the received encrypted data file;
determine, based on the received fingerprint, whether or not the received encrypted data file is a duplicate of a previously stored encrypted data file;
store the received encrypted data file in the first memory and update the first and second mapping tables in response to determining that the received encrypted data file is not a duplicate of any previously stored encrypted data file; and
update the first mapping table to associate the received user address with an existing fingerprint in response to determining that the received encrypted data file is a duplicate of a previously stored encrypted data file.

2. The system of claim 1, wherein the received encrypted data file comprises a received non-deterministically encrypted data file.

3. The system of claim 2, wherein the received fingerprint is received in an encrypted fingerprint file and wherein the instructions further cause the one or more processors to decrypt the encrypted fingerprint file.

4. The system of claim 2, further comprising a client side component comprising:
one or more client side processors; and
a client side non-transitory computer-readable medium storing client side instructions that, when executed by the one or more client side processors, cause the one or more client side processors to:
receive raw data;
generate the received fingerprint from the raw data;
encrypt the raw data using non-deterministic encryption to produce the received non-deterministically encrypted data file.

5. The system of claim 4, wherein the client side instructions further cause the one or more client side processors to generate the received fingerprint from the raw data using a hashing function.

6. The system of claim 4, wherein the client side instructions further cause the one or more client side processors to encrypt the received fingerprint file and wherein the instructions further cause the one or more processors to decrypt the received fingerprint file.

7. The system of claim 4, wherein the client side component further comprises hardware accelerators configured to perform homomorphic encryption to produce the received non-deterministically encrypted data file.

8. The system of claim 4, wherein the client side component is configured to implement data compression in a bump-in-the-wire fashion.

9. The system of claim 2, wherein the instructions further cause the one or more processors to:
receive a read request specifying a user address;
use the first mapping table to identify a fingerprint associated with the user address;
use the second mapping table to identify a storage location associated with the identified fingerprint; and
retrieve a non-deterministically encrypted data associated with the identified fingerprint from the identified storage location.

10. A computer-implemented method comprising:
receiving a non-deterministically encrypted data file that is associated with a user address;
receiving a fingerprint associated with the non-deterministically encrypted data file;
determining, based on the received fingerprint, whether or not the non-deterministically encrypted data file is a duplicate of a previously stored non-deterministically encrypted data file;
storing the non-deterministically encrypted data file in response to determining that the non-deterministically encrypted data file is not a duplicate of any previously stored non-deterministically encrypted data file; and
associating the user address with a previously stored non-deterministically encrypted data file in response to determining that the encrypted data file is a duplicate of the previously stored non-deterministically encrypted data file.

11. The method of claim 10, wherein determining whether or not the non-deterministically encrypted data file is a duplicate comprises accessing a mapping table that associates fingerprints with storage locations of previously stored non-deterministically encrypted data files.

12. The method of claim 10, wherein associating the user address with the previously stored non-deterministically encrypted data file comprises updating a mapping table that associates user addresses with fingerprints.

13. The method of claim 10, wherein the non-deterministically encrypted data file comprises a homomorphically encrypted data file.

14. A computer-implemented method comprising:
receiving raw data;
using a hashing function to generate a fingerprint from the raw data;
generating a non-deterministically encrypted data file by non-deterministically encrypting the raw data;
encrypting the fingerprint; and
transmitting the non-deterministically encrypted data file along with the encrypted fingerprint to a storage node.

15. The method of claim 14, wherein generating the non-deterministically encrypted data file comprises homomorphically encrypting the raw data.

16. The method of claim 14, further comprising compressing non-deterministically encrypted data file in a bump-in-the-wire fashion.

17. The method of claim 14, wherein the transmitting further comprises transmitting a user address associated with the non-deterministically encrypted data file and the encrypted fingerprint.

18. The method of claim 17, further comprising:
receiving the non-deterministically encrypted data file, the encrypted fingerprint, and the user address at the storage node;
determining, based on the received fingerprint, whether or not the non-deterministically encrypted data file is a duplicate of a previously stored non-deterministically encrypted data file;
storing the non-deterministically encrypted data file in response to determining that the non-deterministically encrypted data file is not a duplicate of any previously stored non-deterministically encrypted data file; and
associating the user address with a previously stored non-deterministically encrypted data file in response to determining that the encrypted data file is a duplicate of a previously stored non-deterministically encrypted data file.

19. The method of claim 18, further comprising:
receiving a read request at the storage node, the read request specifying a requested user address;
identifying a fingerprint associated with the requested user address;
identifying a storage location associated with the identified fingerprint; and
retrieving a non-deterministically encrypted data associated with the identified fingerprint from the identified storage location.

20. The method of claim 18, further comprising:
receiving an erase request at the storage node, the erase request specifying a requested user address;
identifying a fingerprint associated with the requested user address;
disassociating the identified fingerprint from the requested user address;
determining whether the identified fingerprint is associated with another user address; and
erasing a non-deterministically encrypted data associated with the identified fingerprint in response to determining that the identified fingerprint is not associated with another user address, wherein the non-deterministically encrypted data associated with the identified fingerprint is not erased in response to determining that the identified fingerprint is associated with another user address.
